(19) United States
(12) Patent Application Publication
(10) Pub. No.: US 2007/0193422 A1
(43) Pub. Date: Aug. 23, 2007

(54) Apparatus and Method for Repairing Damaged Pipe

(76) Inventor: Robert P. Raber, Alta Loma, CA (US)

Correspondence Address: CONNOLLY BOVE LODGE & HUTZ LLP, P.O. BOX 2207, WILMINGTON, DE, 19899, US

(21) Appl. No.: 11/675,249

(22) Filed: Feb. 15, 2007

Related U.S. Application Data
(60) Provisional application No. 60/774,378, filed on Feb. 17, 2006.

(51) Int. Cl. B23B 3/22

(52) U.S. Cl. 82/113

(57) ABSTRACT

An apparatus and method for repairing a damaged pipe is disclosed. A securing arm is adapted to hold the damaged pipe against a work surface. A brace plate having a central aperture is affixed to the work surface. A bevel plate having an offset aperture is affixed to the brace plate such that the offset aperture is aligned with the central aperture. A winch, which includes a cable, is also affixed to the work surface. A mandrel is removably affixed to an end of the cable. The winch is used to pull the mandrel through the damaged pipe.

### PRIORITY

Priority is claimed to Provisional Patent Application Ser. No. 60/774,378, filed Feb. 17, 2006, the entire disclosure of which is incorporated herein by reference.

### BACKGROUND OF THE INVENTION

1. Field of the Invention

The field of the present invention is repair of damaged metal pipe.

2. Background

Currently, metal pipe which is transported into the United States from overseas suffers significant damage to much of the product. Depending upon the material from which the pipe is constructed, the diameter of the pipe, and the wall thickness of the pipe, it is not uncommon for 25%-40% of the imported pipes to be damaged and considered unusable. Some of the damaged pipe in the 4″ to 6″ diameter range are reparable by currently known methods. Such repairs, however, can be costly and time intensive. Oftentimes, damaged pipes that are repairable sit in yards and rust before repairs can be performed. Damaged pipe which has a diameter of 3″ and below is generally discarded as scrap. In view of the significant losses incurred by importers of metal pipe, a great need exists for systems and methods that can be employed to repair damaged pipe to a state that renders the repaired pipe sellable in the marketplace.

### SUMMARY OF THE INVENTION

The present invention is directed towards an apparatus and method for repairing damaged pipe. In both the apparatus and method, a cable and winch are used to pull a mandrel through a pipe, thereby causing the inner diameter of the pipe to conform to the outer diameter of the mandrel.

In a first separate aspect of the present invention, a securing arm is adapted to hold the damaged pipe against a work surface. A winch with a cable is affixed to the work surface, and a mandrel is removably affixed to an end of the cable. A brace place having a central aperture is also affixed to the work surface. A bevel plate is affixed to the brace plate. The bevel plate includes an offset aperture which is aligned with the central aperture of the brace plate. With this configuration, the winch may be used to pull the mandrel through the damaged pipe.

In a second separate aspect of the present invention, the winch is a variable speed hydraulic winch.

In a third separate aspect of the present invention, a variable pressure compensated hydraulic pump is used to operate the winch.

In a fourth separate aspect of the present invention, the bevel plate includes an annular shoulder and an annular beveled surface, both of which are disposed at the periphery of the offset aperture. During operation, damaged or flared ends of the pipe are repaired by forcing the end of the pipe into the annular beveled surface and against the annular shoulder as the mandrel is pulled through the pipe.

In a fifth separate aspect of the present invention, pipes that are bent resulting from damage to the sidewall are secured in place between a work surface and a securing arm. The pipe is forced to lie approximately straight between the work surface and the securing arm. With the pipe held in this manner, the mandrel is drawn through the pipe. As the mandrel passes the bent point in the pipe, the metal undergoes stress-relief, thereby causing the pipe to unbend.

In a sixth separate aspect of the present invention, any of the foregoing aspects may be employed in combination.

Accordingly, an improved apparatus and method for repairing damaged pipe are disclosed. Other objects and advantages will appear hereinafter.

### BRIEF DESCRIPTION OF THE DRAWINGS

In the drawings, wherein like reference numerals refer to similar components:

FIG. 1 is a partial top schematic view of an apparatus for removing dents from pipe;

FIG. 2 is a side view of the apparatus of FIG. 1;

FIG. 3 is a side view of a brace plate for the apparatus of FIG. 1;

FIG. 4 is a side view of a bevel plate for the apparatus of FIG. 1;

FIG. 5 is a top view of the bevel plate of FIG. 4;

FIG. 6 is side view of a pipe hold-down for the apparatus of FIG. 1;

FIG. 7 is a sectional view of a first mandrel;

FIG. 8 is a sectional view of a second mandrel; and

FIG. 9 is a sectional view of a third mandrel.

### DETAILED DESCRIPTION OF THE PREFERRED EMBODIMENTS

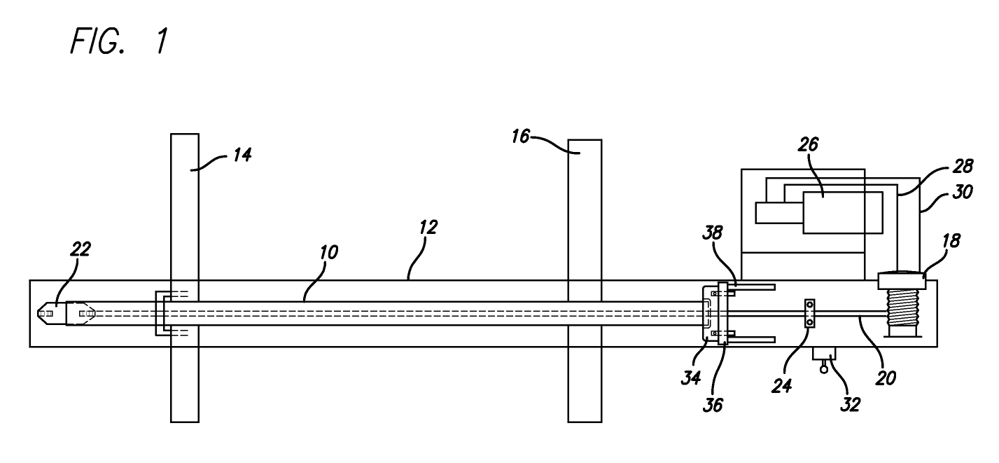

Turning in detail to the drawings, FIG. 1 illustrates an apparatus for removing dents from metal pipes. A pipe 10 is placed on a bench 12. Two racks 14, 16 facilitate placement and removal of the pipe 10 on and from the bench 12. An hydraulic-powered winch 18 is positioned on the bench 12 such that the cable 20 from the winch 18 can be extended lengthwise through the pipe 10. The end of the cable 20 is threaded so that a mandrel 22 may be attached. As described in more detail below, the mandrel 22 is pulled through damaged pipe to push out dents incurred during shipment. The winch 18 is preferably a variable speed winch capable of retracting the cable 20 at a rate of at least 50 ft/min, although any appropriate speed will suffice. A centering block 24 is bolted to the bench 12 between the winch 18 and the pipe 10 to ensure that the cable 20 travels approximately through the center of the pipe 10. The winch 18 is powered by a variable pressure compensated hydraulic pump 26 through hydraulic lines 28, 30. A manual switch 32 is connected to the hydraulic pump 26 to enable manual control of the speed at which the winch 18 retracts the cable 20.

One end of the pipe 10 is held in place by a bevel plate 34. The bevel plate 34 is affixed to a brace place 36, which is in turn affixed to the bench 12 and further supported by buttresses 38. Different bevel plates are employed depending upon diameter and wall thickness of the pipe being repaired.

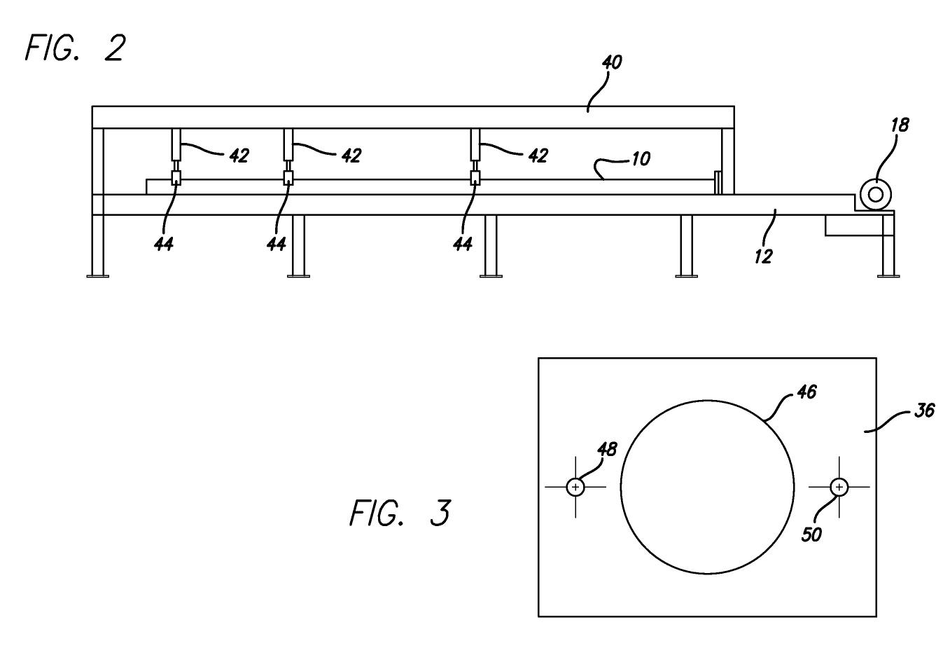

FIG. 2 illustrates the securing arm 40 in position to hold a pipe 10 down on the bench 12. The securing arm 40 may be constructed to drop into place from directly above the bench 12 or to rotate into place from a pivot point. The securing arm 40 includes several fingers 42, each of which includes a hold-down 44 at the tip. Each hold-down 44 is sized appropriately for the pipe being repaired.

The brace plate 36, shown in FIG. 3, includes a central aperture 46 through which the cable passes and two holes 48, 50 for securing the bevel plate thereto. The central aperture 46 is preferably just larger than the inner diameter of the largest pipe intended to be repaired with the apparatus. By sizing the central aperture 46 in this manner, mandrels of all sizes are able to pass through the central aperture 46 as the mandrel emerges from the pipe.

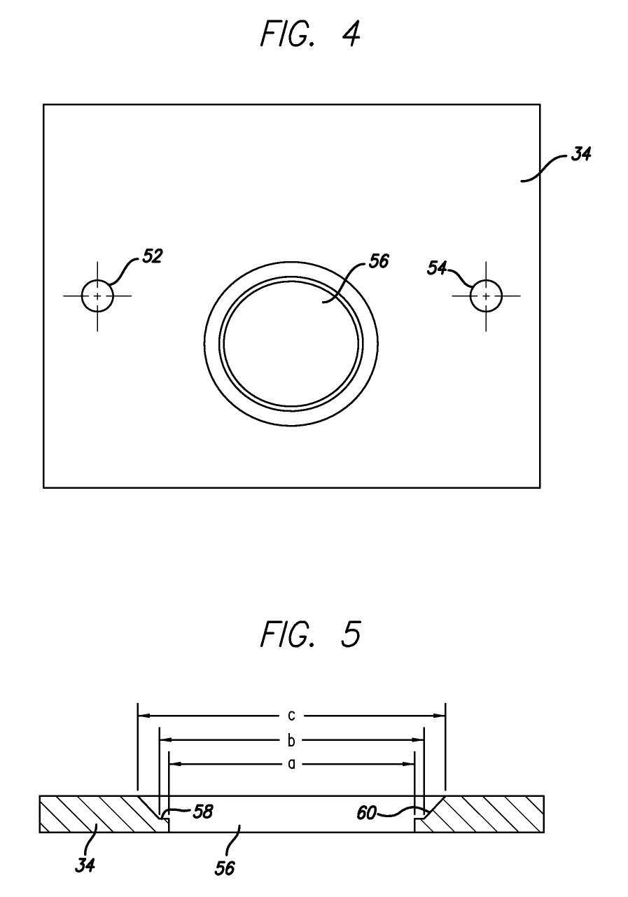

The bevel plate 34 is illustrated in FIG. 4. Two holes 52, 54 are included for securing the bevel plate 34 to the brace plate 36. The bevel plate includes an offset aperture 56 in which one end of the pipe 10 is placed when resting on the bench 12. When the bevel plate 34 is affixed to the brace plate 36, the lower edge of the offset aperture 56 in the bevel plate is intended to be approximately tangent with the lower edge of the central aperture 46 in the brace plate 36. The offset aperture 56 is dimensioned as shown in FIG. 5. The smallest dimension of the offset aperture 56, ‘a’, is approximately the same as the inner diameter of the pipe being repaired. From this smallest dimension of the offset aperture 56, an annular shoulder 58 is created within the offset aperture having an inner dimension of ‘a’ and an outer dimension of ‘b’. The width of the shoulder is approximately equal to the wall thickness of the pipe being repaired. An annular beveled surface 60 is also created within the offset aperture 56. This annular beveled surface 60 has an outer dimension of ‘c’ and an inner dimension of ‘b’. Empirically derived values of the outer dimension, ‘c’, of the annular beveled surface 60 are included in Table 1. One end of the pipe is pressed against the annular beveled surface 60, as the mandrel is drawn through the pipe by the winch, to repair flare damage at the end of the pipe. In this manner, the end of the pipe may be nearly or wholly returned to its pre-damaged specification.

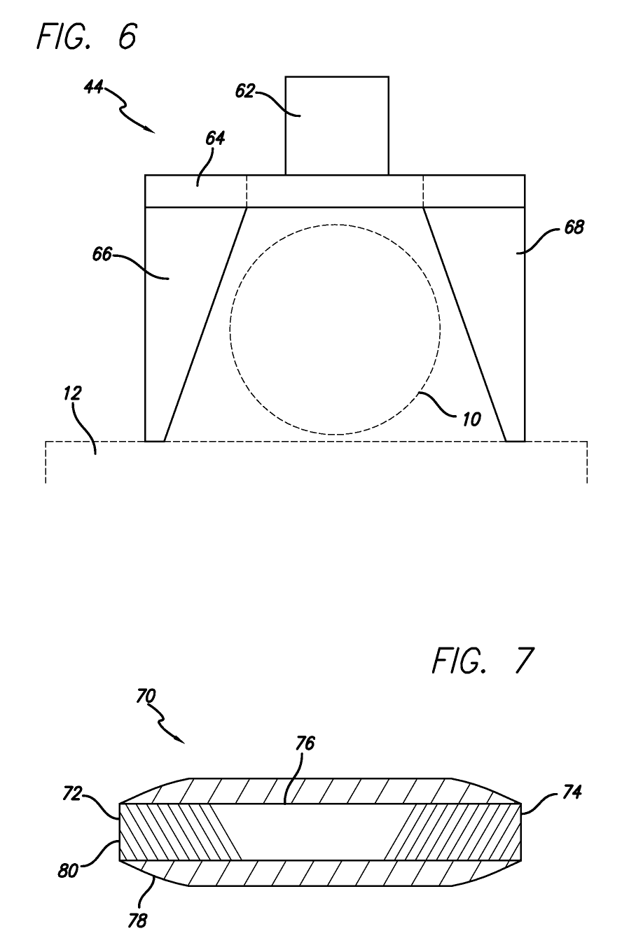

FIG. 6 illustrates a hold-down 44 that is affixed to the securing arm 40 of the apparatus. The hold-down 44 is attached to the fingers of the securing arm at the block 62. The pipe is secured against the bench 12 by a plate 64 and two legs 66, 68. The space between the bench 12, the plate 64, and the legs 66, 68 is slightly larger than the outer diameter of the pipe being repaired. This allows the securing arm and its associated structure to hold the pipe on the bench while not placing unnecessary pressure on the pipe.

FIGS. 7-9 illustrate three implementations of mandrels, each of which is generally cylindrically shaped and preferably constructed using a hardened steel. The mandrel 70 shown in FIG. 7 is double-sided and can be drawn through a pipe with either edge 72, 74. The mandrel 70 has a central bore 76 which is threaded near both edges 72, 74 for attaching to the threaded end of the cable. Each edge 72, 74 of the mandrel 70 has a rounded surface 78 leading from the bore opening 80 to the full circumference of the mandrel 70 at its outer diameter. The curvature of this rounded surface 78 varies depending upon the mandrel and pipe sizes (including diameters and wall thickness) and is empirically determined based on the diameter of the pipe being repaired. The length of the mandrel and its outer diameter are also empirically determined. The outer diameter of the mandrel is approximately the same as, but not more than, the inner diameter of the pipe. Preferably, the tolerance on the outer diameter of the mandrel ranges between 0.000 and −0.005″ as compared to the inner diameter of the pipe. Table 1 includes a list of dimensions for mandrels that have been empirically determined for specific pipe sizes.

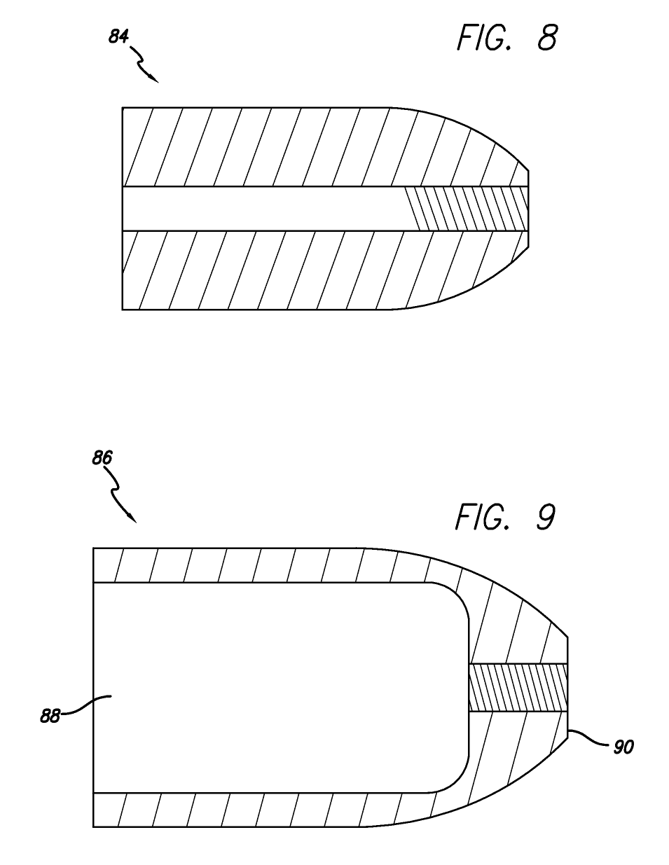

FIG. 8 illustrates a single-sided mandrel 84. This mandrel 84 is dimensioned for yet a larger pipe. One reason for making a single-sided mandrel instead of a double-sided mandrel is to reduce the weight of the mandrel by eliminating the additional length needed for the second side.

FIG. 9 illustrates another embodiment of single-sided mandrel 86. This mandrel 86 includes a large hollow core 88 opposite the leading edge 90. The hollow core 88 helps to further reduce the weight of a mandrel intended for use with larger diameter pipes.

TABLE 1
Comparative Dimensions for Pipes and Pipe Dent Removal Apparatus
(all dimensions are in inches)

| | | | | | Mandrel | |
|---|---|---|---|---|---|---|
| | | | Bevel | Mandrel | End | Mandrel |
| Pipe OD | Pipe ID | Pipe Wall | OD | OD | Curvature | Length |
| 1.660 | 1.494 | 0.083 | 2.16 | 1.494 | 1.5 | 5 |
| 1.900 | 1.710 | 0.095 | 2.4 | 1.710 | 1.5 | 5 |
| 2.375 | 2.185 | 0.095 | 2.875 | 2.185 | 2 | 6.5 |
| 2.875 | 2.709 | 0.083 | 3.375 | 2.709 | 2.5 | 6.75 |
| 3.5 | 3.320 | 0.090 | 4 | 3.320 | 3 | 6.25 |
| 4.5 | 4.250 | 0.125 | 5 | 4.250 | 4 | 6.875 |
| 4.5 | 4.298 | 0.101 | 5 | 4.298 | 4 | 6.875 |
| 6.625 | 6.357 | 0.134 | 7.125 | 6.357 | 6 | 9 |
| 6.625 | 6.386 | 0.120 | 7.125 | 6.386 | 6 | 9 |

In practice, the pipe repairing apparatus is relatively simple to use. First, a pipe is secured between the bench and the securing arm, with one end placed against the beveled surface of the bevel plate. If the pipe has a bend in it, the bend point of the pipe is preferably placed facing away from the bench so that the pipe actually bends away from the bench. The securing arm will force a bent pipe to lay substantially flat, but it will not actually unbend the pipe. Once the pipe is secured, the cable is unwound from the winch and threaded through the length of the pipe. An appropriately sized mandrel is then affixed to the end of the cable emerging from the pipe. The operator may then activate the hydraulic pump so that the winch retracts the cable. The mandrel is thus drawn into and entirely through the pipe, emerging from the central aperture in the brace plate. The operator may selectively adjust the speed of the winch depending upon where and how severe the damage is to the pipe.

As the mandrel is drawn through the pipe, its shape and size force out dents in the sidewall of the pipe. Theoretically, any dent may be repaired if the sidewall displacement for that dent is less than the elastic range of the material of which the pipe is constructed. Additionally, bends in the pipe may be repaired because the material undergoes stress-relief as the mandrel passes the bend point.

Thus, an apparatus and method for removing dents from pipe are disclosed. While embodiments of this invention have been shown and described, it will be apparent to those skilled in the art that many more modifications are possible without departing from the inventive concepts herein. The invention, therefore, is not to be restricted except in the spirit of the claims.

What is claimed is:

1. An apparatus for repairing a damaged pipe, the apparatus comprising:
a work surface;
a winch affixed to the work surface, the winch including a cable;
a mandrel removably affixed to an end of the cable;
a brace plate affixed to the work surface, the brace place having a central aperture;
a bevel plate affixed to the brace plate, the bevel plate having an offset aperture aligned with the central aperture; and
a securing arm adapted to hold the damaged pipe against the work surface.

2. The apparatus of claim 1, further comprising a hydraulic pump operatively connected to the winch.

3. The apparatus of claim 2, wherein the hydraulic pump comprises a variable pressure compensated hydraulic pump.

4. The apparatus of claim 2, wherein the winch comprises a variable speed hydraulic winch.

5. The apparatus of claim 1, wherein the bevel plate includes an annular shoulder and an annular beveled surface, both disposed at a periphery of the offset aperture.

6. The apparatus of claim 5, wherein the annular shoulder has a width that is approximately equal to a wall thickness of the damaged pipe.

7. The apparatus of claim 1, wherein the securing arm is pivotally affixed to the work surface.

8. The apparatus of claim 1, wherein the securing arm comprises a plurality of fingers extending toward the work surface, each finger including a tip adapted to secure the damaged pipe against the work surface.

9. An apparatus for repairing a damaged pipe, the apparatus comprising:
a work surface;
a variable speed hydraulic winch affixed to the work surface, the winch including a cable;
a variable pressure compensated hydraulic pump operatively connected to the winch.
a mandrel removably affixed to an end of the cable;
a brace plate affixed to the work surface, the brace place having a central aperture;
a bevel plate affixed to the brace plate, the bevel plate including an offset aperture, an annular shoulder, and an annular beveled surface, wherein the annular shoulder and the annular beveled surface are disposed at a periphery of the offset aperture, and the offset aperture is aligned with the central aperture; and
a securing arm adapted to hold the damaged pipe against the work surface.

10. The apparatus of claim 9, wherein the annular shoulder has a width that is approximately equal to a wall thickness of the damaged pipe.

11. The apparatus of claim 9, wherein the securing arm is pivotally affixed to the work surface.

12. The apparatus of claim 9, wherein the securing arm comprises a plurality of fingers extending toward the work surface, each finger including a tip adapted to secure the damaged pipe against the work surface.

13. A method for repairing a damaged pipe, the method comprising:
securing a damaged pipe against a work surface;
abutting one end of the damaged pipe against a braced bevel plate, the bevel plate including an offset aperture;
running a cable through the offset aperture and the damaged pipe, wherein a first end of the cable is wrapped around a winch;
affixing a mandrel to a second end of the cable; and
operating the winch to pull the mandrel through the damaged pipe.

14. The method of claim 13, wherein operating the winch includes operating the winch using a hydraulic pump.

15. The method of claim 14, wherein the hydraulic pump comprises a variable pressure compensated hydraulic pump.

16. The method of claim 14, wherein the winch comprises a variable speed hydraulic winch.

17. The method of claim 13, wherein abutting one end of the damaged pipe against the braced bevel plate includes abutting one end of the damaged pipe against one of a beveled annular surface or an annular shoulder on the bevel plate, wherein the beveled annular surface is adjacent the annular shoulder and both are disposed at a periphery of an offset aperture in the bevel plate.

18. A method for repairing a damaged pipe, the method comprising:
securing a damaged pipe against a work surface;
abutting one end of the damaged pipe against one of a beveled annular surface or an annular shoulder on a bevel plate, wherein the beveled annular surface is adjacent the annular shoulder and both are disposed at a periphery of an offset aperture in the bevel plate;
running a cable through the offset aperture and the damaged pipe, wherein a first end of the cable is wrapped around a variable speed hydraulic winch;
affixing a mandrel to a second end of the cable; and
operating the winch using variable pressure compensated hydraulic pump to pull the mandrel through the damaged pipe.
